(19) United States
(12) Patent Application Publication
(10) Pub. No.: US 2014/0205264 A1
(43) Pub. Date: Jul. 24, 2014

(54) VIDEO PLAYING METHOD, TERMINAL AND COMPUTER READABLE MEDIUM

(71) Applicant: TENCENT TECHNOLOGY (SHENZHEN) COMPANY LIMITED, Shenzhen City (CN)

(72) Inventors: SEN LIN, Shenzhen City (CN); QI-FEI CHENG, Shenzhen City (CN); YU-LONG LI, Shenzhen City (CN); BAO ZHAO, Shenzhen City (CN); ZENG-LIANG ZHENG, Shenzhen City (CN)

(73) Assignee: TENCENT TECHNOLOGY (SHENZHEN) COMPANY LIMITED, Shenzhen City (CN)

(21) Appl. No.: 14/222,498

(22) Filed: Mar. 21, 2014

Related U.S. Application Data
(63) Continuation of application No. PCT/CN2012/082175, filed on Sep. 27, 2012.

(30) Foreign Application Priority Data
Oct. 12, 2011 (CN) 201110307998.6

(51) Int. Cl. H04N 9/79

(52) U.S. Cl. CPC H04N 9/79
USPC 386/232

(57) ABSTRACT

A video playing method including: retrieving description information associated with a requested video according to a video playing request, wherein the description information includes information describing at least one supported definition of the requested video; and detecting the current network condition, and selecting a definition matching to the current network condition to play the requested video. A video playing apparatus is further provided. By selecting a definition matching to the current network environment to play, the video playing method and apparatus would ensure the fluent playing process and improve the video watching experience of the user.

### PRORITY

This application is a U.S. continuation application under 35 U.S.C. §111(a) claiming priority under 35 U.S.C. §120 and 365(c) to International Application No. PCT/CN2012/082175 filed Sep. 27, 2012, which claims priority of a Chinese patent application serial No. 201110307998.6, titled “video playing method and apparatus” and filed on Oct. 12, 2011, the contents of which are incorporated by reference herein in their entirety for all intended purposes.

### TECHNICAL FIELD

The present invention relates to video playing technology, and more particularly to a video playing method, a video playing terminal and a computer readable medium.

### BACKGROUND

In conventional video playing solutions, video playing terminals retrieve video contents from servers, and servers usually provide several versions of different definitions for each video. For example, the server may provide high definition version, standard definition version or ultra-high definition version for a multimedia content. The different versions are stored in independent video files and each of them has a different identifier (ID). The user could select the intended definition of the video to play. However, the bit rate of a video file depends on its definition. For example, a video file of the high definition has a bit rate of 500 Kbps, and a video file of the ultra-high definition has a bit rate of 1 Mbps. Correspondingly, different minimum network bandwidth is required to play online video file of different definitions fluently. Generally, a network bandwidth of 500 Kbps is required to fluently play a high definition video, and a network bandwidth of 1 Mbps is required to fluently play an ultra-high definition video. In conventional video playing solutions, users usually don't know which definition is matching to their network bandwidth, and thus they can't get better video watching experience. For example, users may select the definition of a high bit rate which frequently causing buffering due to the inadequate network bandwidth and waste of the user's time.

### SUMMARY

To avoid the influent video playing, a video playing method and apparatus are provided. A computer readable medium storing computer executable instructions to cause the computer to perform the video playing method is further provided.

A video playing method includes: receiving a video playing request from a user; retrieving description information associated with a requested video designated by the video playing request, the description information comprising: definition information describing at least one supported definition of the requested video; and detecting current network condition, and selecting a definition matching to the current network condition to play the requested video.

A video playing terminal includes: memory; one or more processors; and one or more modules stored in the memory and configured for execution by the one or more processors, the one or more modules includes instructions: to receive a video playing request from a user; to retrieve description information associated with a requested video designated by the video playing request, the description information comprising: definition information describing at least one supported definition of the requested video; to detect current network condition; and to select a definition matching to the current network condition to play the requested video.

A computer readable medium, storing one or more programs, the one or more programs comprising instructions, which when executed by a video playing terminal, cause the video playing terminal to perform the above method.

By selecting a definition matching to the current network environment to play, the video playing method and terminal would ensure the fluent playing process.

### BRIEF DESCRIPTION OF THE DRAWINGS

FIG. 1 illustrates a runtime environment according to some embodiments.

FIG. 2 is a block diagram illustrating a video playing terminal according to an embodiment.

FIG. 3 is a schematic view of a definition listing table provided in the present disclosure.

FIG. 4 is a schematic view of a description information list of a video provided in the present disclosure.

FIG. 5 is a flow chart of a video playing method in accordance with a first embodiment of the present invention.

FIG. 6 is a flow chart of a video playing method in accordance with a second embodiment of the present invention.

FIG. 7 is a block diagram of a video playing apparatus provided in accordance with a third embodiment of the present invention.

FIG. 8 is a block diagram illustrating an implemention example of an information retrieving module in the video playing apparatus of FIG. 5.

FIG. 9 is a block diagram illustrating a first implemention example of a playing module in the video playing apparatus of FIG. 5.

FIG. 10 is a block diagram illustrating a second implemention example of a playing module in the video playing apparatus of FIG. 5.

FIG. 11 is a block diagram illustrating a third implemention example of a playing module in the video playing apparatus of FIG. 5.

FIG. 12 is a block diagram of a video playing apparatus provided in accordance with a fourth embodiment of the present invention.

### DETAILED DESCRIPTION OF PREFERRED EMBODIMENTS

To make the technical solutions and advantages of the present invention more apparently, embodiments of the present invention will be described in detail accompanying with figures as follows.

In the technical solution provided in the present disclosure, a video playing terminal retrieve description information of a requested video, responding to a video playing request from a user. The description information includes definition information that describes at least one supported definition of the requested video. The video playing apparatus further detects the current network condition and selects a definition matching to the current network condition to play. As a result, influent playing due to mismatching of the current network condition and the selected definition is avoided, and the fluent video playing is ensured.

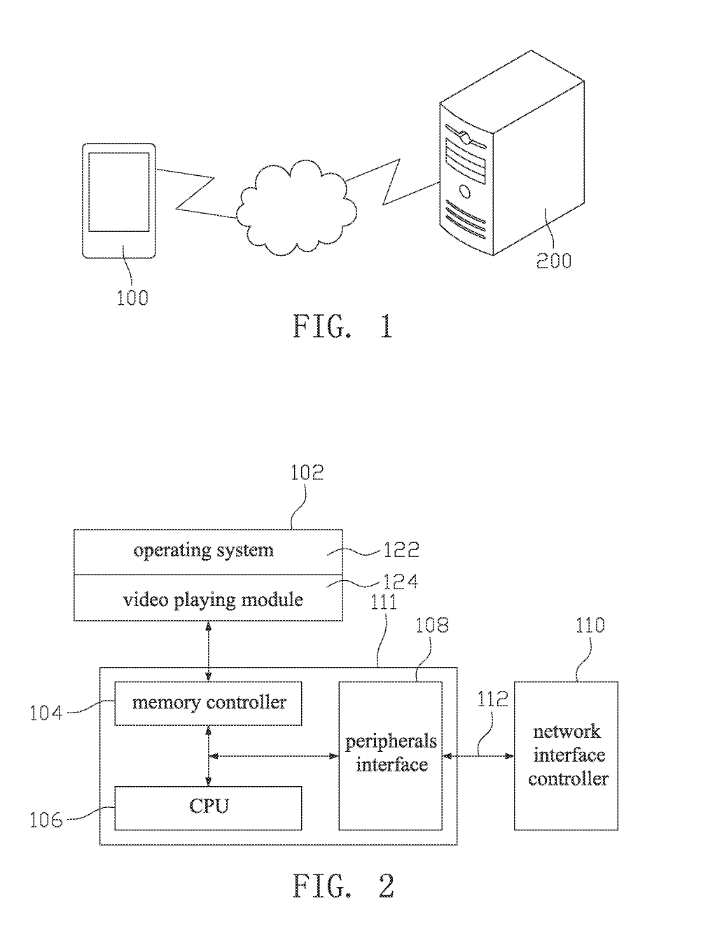

In one embodiment, the description information is retrieved from a server. For example, referring to FIG. 1, a video playing terminal 100 is connected to a server 200 via the internet. After receiving the video playing request from the user, the video playing terminal 100 sends a request to the server 200 for retrieving description information of a requested video. The server 200 returns the description information according to the request.

Examples of the video playing terminal 100 includes, but not limited to, a television, a desktop computer, a laptop computer, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

FIG. 2 is a schematic block diagram of the video playing terminal 100. As shown in FIG. 1, the video playing terminal 100 includes a memory 102, a memory controller 104, one or more processors 106, a peripherals interface 108, and a network interface controller 110. These components communicate over the one or more communication buses or signal lines 112. It should be appreciated that the video playing terminal 100 is only one example of the video playing terminal, and that the video playing terminal 100 may have more or fewer components that shown, or a different configuration of components. The various components shown in FIG. 2 may be implemented in hardware, software or a combination of both hardware and software, including one or more signal processing and/or application specific integrated circuits.

The memory 102 may include high speed random access memory and may also include non-volatile memory, such as one or more magnetic disk storage devices, flash memory devices, or other non-volatile solid state memory devices. In some embodiments, the memory 102 may further include storage remotely located from the one or more processors 106, for instance network attached storage accessed via network interface controller 110 and a communications network (not shown) such as the Internet, intranet(s), Local Area Networks (LANs), Wireless Local Area Networks (WLANs), Storage Area Networks (SANs) and the like, or any suitable combination thereof Access to the memory 102 by other components of the server 100, such as the CPU 106 and the peripherals interface 108 may be controlled by the memory controller 104.

The peripherals interface 108 couples the input and output peripherals of the device to the CPU 106 and the memory 102. The one or more processors 106 run various software programs and/or sets of instructions stored in the memory 102 to perform various functions for the video playing terminal 100 and to process data.

In some embodiments, the peripherals interface 108, the CPU 106, and the memory controller 104 may be implemented on a single chip, such as a chip 111. In some other embodiments, they may be implemented on separate chips.

The network interface controller 110 receives and sends network signals. The network interface controller 110 converts electrical signals/optical signals/electromagnetic waves and communicates with other devices such as other servers or routers. As such, the server 100 may receive a web request through the network interface controller 110 and send data to a client using the network interface controller 110.

In some embodiments, there are software components stored in the memory 102. For example, the software components include an operating system 122, and a video playing module 124.

The operating system 122 (e.g., Darwin, RTXC, LINUX, UNIX, OS X, WINDOWS, IOS, Android, WINDOWS MOBILE) includes various software components and/or drivers for controlling and managing general system tasks (e.g., memory management, storage device control, power management, etc.) and facilitates communication between various hardware and software components.

The video playing module 124, for example, provides an interface that shows a list of videos. The user could select a video in the list to play; in other words, the user may launch a video playing request in the interface. After receiving the video playing request, the video playing module 124 performs a video playing method, which is described in the following embodiments.

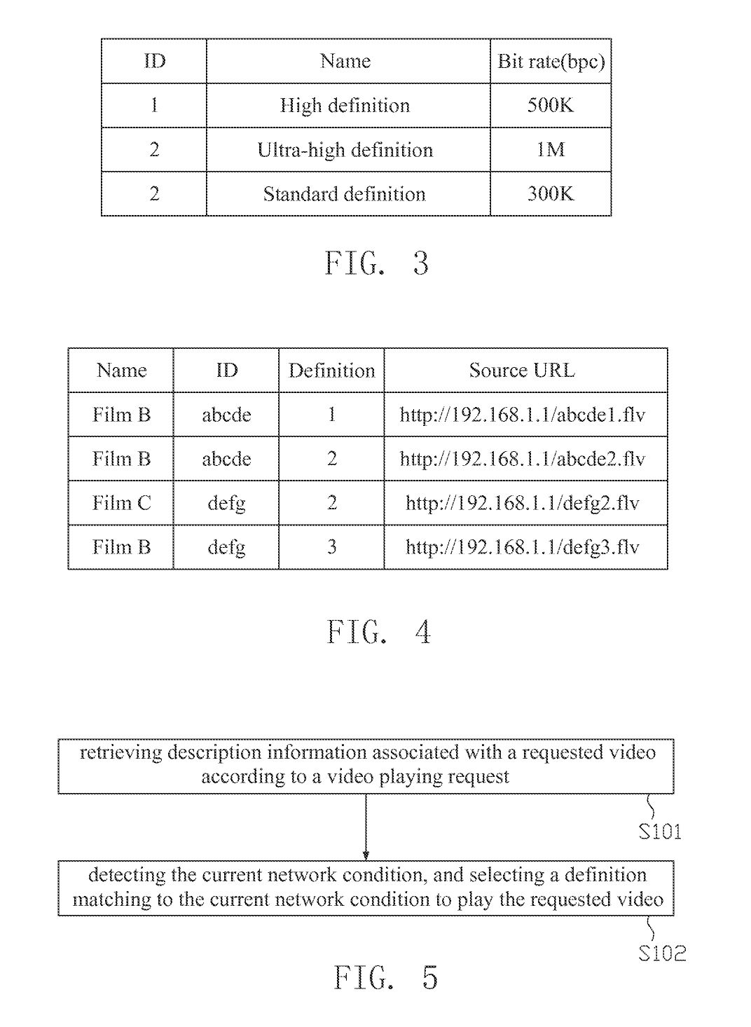

The description information of the requested video may include: definition information that describes at least one supported definition of the video. The definition information may include a definition identifier (ID) which uniquely representing a definition. For example, ID number “1” represents a first definition (e.g., 500 Kbps), and ID number “2” represents a second definition (e.g., 1 Mbps). The definition information may also include the names of the definition such as standard definition, high definition, full high definition, and ultra-high definition etc. The definition information may also include the bit rate such as 300 Kbps, 500 Kbps etc. It is to be noted that the bit rate of a video file is equal to a bandwidth required to play the video file fluently. The definition information may be stored in a data file or a database. The data file or the database can be deployed in the video playing terminal or a server (e.g., the server 200), and the server may store the definition information in a listing table, as shown in FIG. 3, which is a schematic view of a definition listing table provided in the present disclosure.

In the illustrated example of FIG. 3, the definition named “high definition” has an ID of “1” and a bit rate of 500 Kbps; the definition named “ultra-high definition” has an ID of “2” and a bit rate of 1 MKbps; and the definition named “standard definition” has an ID of “3” and a bit rate of 300 Kbps. It is to be noted the fields contained in the definition listing table that stored in the served can be configured by the user according to the practical requirements. For example, the definition listing table may only include one or two of “high definition”, “ultra-high definition” and “standard definition”.

The description information of the requested video may also include the identifier or the name of the requested video, and the source universal resource locator (URL) for each definition. The description information may be stored in video playing terminal 100 or the server 200 (e.g., a video server), and the server 200 may store the description information in a listing table, as illustrated in FIG. 4, which is a schematic view of a description information list of a video provided in the present disclosure. In the illustrated example of FIG. 4, each definition version of a same video has the same video ID. For example, a video ID of a film B corresponding to a definition “1” is “abcde”, and a video ID of the film B corresponding to a definition “2” is also “abcde”. In addition, a video ID of a film C corresponding to a definition “2” is “defg”, and a video ID of the film corresponding to a definition “3” is also “defg”. According to the manner that a same video ID is used to associate video sources of different definitions, the user needn't to individually search for videos corresponding to different definitions, and it is also very convenient for the user to switch the definitions of a same video. The definition information of videos in the listing table of FIG. 4 can be obtained from the definition information shown in FIG. 3. It is to be understood that the fields contained in the description information listing table of videos that stored in the server can be configured by the user according to the practical requirements. For example, the filed “definition” in the listing table may include the name or bit rate of the corresponding definition. It is further to be noted that the server can also store the definition information and the description information in a same listing table, and store the description information in other manners (e.g., in a database).

The network condition may include network bandwidth. For example, the network bandwidth may be 500 Kbps, 2 Mbps, etc. The network condition may further include network delay information, for example, transmission delay, propagation delay, and processing delay etc. Transmission delay (or store-and-forward delay, also known as packetization delay) is the amount of time required to push all of the packet's bits into the wire. In other words, this is the delay caused by the data-rate of the link. Propagation delay is the amount of time it takes for the head of the signal to travel from the sender to the receiver. Processing delay is the time it takes routers to process the packet header. The network condition may yet further include other parameters that representing network status such as bandwidth-delay product. Bandwidth-delay product refers to the product of a data link's capacity (in bits per second) and its end-to-end delay (in seconds).

In one embodiment, the delay information is obtained by calling network testing interface provided by the operating system. Taking the Windows system as an example, the command “ping” or the command “traceroute” can be used in the command line to trace the transmission of data packets on the network. The network bandwidth can be obtained by a special testing process. For example, after downloading a data file from the internet, and the average downloading rate can be used as the network bandwidth.

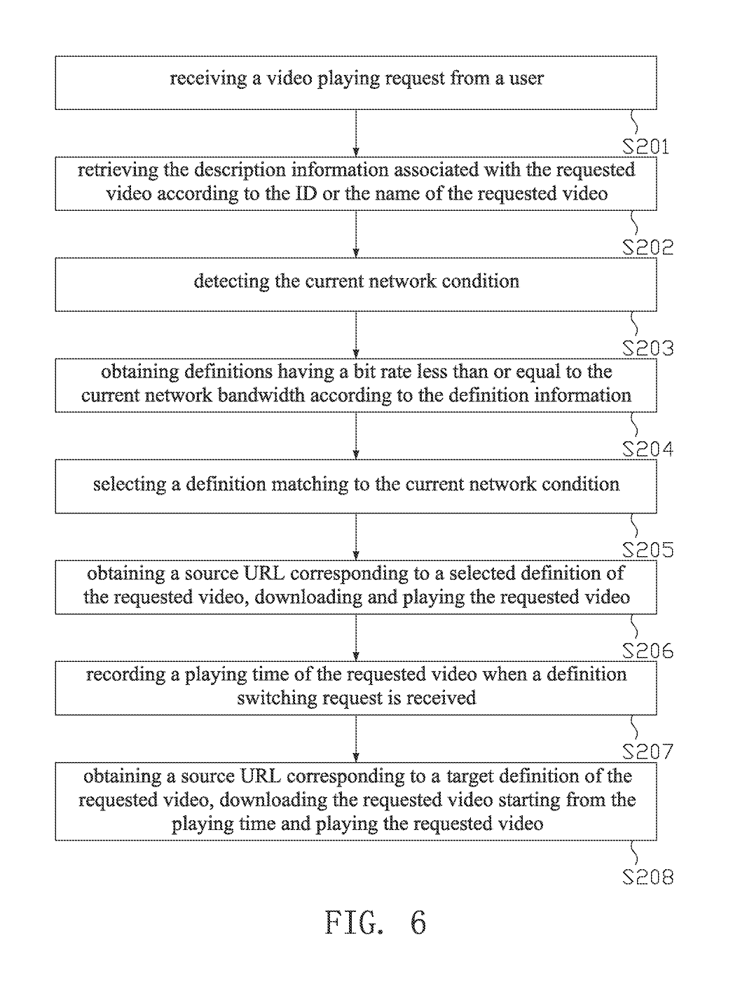

A video playing method in accordance with embodiments will be described in detail below with reference to FIGS. 5 and 6.

Referring to FIG. 5, which is a schematic view of a video playing method in accordance with a first embodiment, the method may include:

Step S101, retrieving description information associated with a requested video according to a video playing request launched by a user.

The user can launch the video playing request by selecting a video from a local playing list provided by the video playing module 124, or through loading a video playing webpage using a browser. In step S101, according to the video playing request launched by the user, the description information associated with the requested video can be obtained. The description information may include definition information describing at least one supported definition of the requested video.

If the description information is stored in the video playing terminal, then the description information can be directly read from the local data file or database. If the description information is stored in the server-side, a web request can be send to the database for retrieving the description information.

Step 102, detecting the current network condition and select a definition matching to the current network condition to play the requested video.

The current network condition may include the current network bandwidth. In step S102, the current network bandwidth can be detected with a known bandwidth detecting software or tool, and a definition matching to the current network bandwidth is selected to play the requested video. The definition matching to the current network bandwidth means that the bit rate is less than or equal to that required by the definition, or in other words, means the definition having a bit rate not more than the current network bandwidth. For example, if the requested video supports three definitions of “standard definition”, “high definition” and “ultra-high definition”, and the current network bandwidth is 480 Kbps, then in step S102, definitions having a bit rate not more than 480 Kbps should be selected. Referring to the listing table shown in FIGS. 3 and 4, the “standard definition” should be selected to play the requested video. In the present embodiment, by selecting a definition having a bit rate not more than the current network bandwidth, the selection of the definition having a high bit rate is avoided, and the influent playing due to the inadequate bandwidth is also avoided.

Referring to FIG. 6, which is a schematic view of a video playing method in accordance with a second embodiment, the method may include:

Step S201, receiving a video playing request from a user.

The user can send the video playing request by selecting a video from a local playing list, or through loading a video playing webpage using a browser. In step S201, the video playing request launched by the user through above manners is received. The video playing request may include the ID or the name of the requested video.

Step S201, retrieving description information associated with the ID or name of the requested video from a server.

In step S202, according to the ID or the name of the requested video sent by the user, the description information can be retrieved from the server. For example, referring to the listing table shown in FIGS. 3 and 4, according to the ID or the name of the requested video, description information, such as the supported definition and the source URL for each definition of the requested video can be read.

The step S201 and the step S202 can be a more detailed implemention example of the step S101 in FIG. 5.

Step S203, detecting the current network condition.

The current network condition may include the current network bandwidth. In step S203, the current network bandwidth can be detected with a known bandwidth detecting software or tool, and the detail detecting procedure can be referred to the known technique.

Step S204, obtaining definitions having a bit rate less than or equal to the current network bandwidth according to the definitions supported by the requested video.

Step S205, selecting a definition matching to the current network condition.

In step S204, the definitions having a bit rate less than or equal to (not more than) the current network bandwidth can be obtained according to the definitions supported by the requested video. For example, as shown in FIG. 4, the film C supports two definitions: “standard definition” and “ultra-high definition”. If the current network bandwidth is 480 Kbps, then in step S204, definitions having a bit rate not more than 480 Kbps can be selected to play. Referring to the listing table shown in FIGS. 3 and 4, the “standard definition” can be selected. Then, in step S205, the “standard definition” is selected to be the definition matching to the current network condition.

Step S206, obtaining a source URL corresponding to the selected definition of the requested video, downloading and playing the requested video.

In step S206, the source URL corresponding to the selected definition of the requested video can be obtained from the server. For example, in step S204, the “standard definition” is selected for the film C, then the source URL corresponding to the “standard definition” of the film C that represented by the ID “3” can be read from the listing table shown in FIGS. 1 and 2. After that, the film C can be downloaded to play according to the source URL. At this time, the downloaded film C can be played by the video playing module 124 or a webpage navigated by a browser.

It is to be noted that the number of the definition(s) matching to the current network condition selected in step S204 may be more than one. For example, the film C supports two definitions: “standard definition” and “ultra-high definition”. If the detected current network bandwidth is 1 Mbps, according to the listing table shown in FIGS. 3 and 4, the “standard definition” and the “ultra-high definition” are both obtained in step S204. In this situation, selecting a definition matching to the current network condition in step S205 can be performed in the following three manners.

Manner 1: selecting a definition having a bit rate most close to the current network bandwidth from the obtained at least one definitions having a bit rate less than or equal to the current network bandwidth as the definition matching to the current network condition.

The primary objective of this manner is to select a definition having a bit rate most close to the current network bandwidth, and the selecting procedure may include the following steps: comparing the bit rate of the obtained at least one definitions and the current network bandwidth, getting the smallest difference between the bit rate and the network bandwidth, and selecting the definition corresponding to the smallest difference. For example, the film C supports two definitions: “standard definition” and “ultra-high definition”. If the network bandwidth is detected to be 1 Mbps (1000 Kbps), as shown in FIGS. 1 and 2, then the two definitions “standard definition” and “ultra-high definition” would be both selected in step S204, wherein the “standard definition” has a bit rate of 300 Kbps and a difference between this bit rate and the network bandwidth is 700 Kbps; the “ultra-high definition” has a bit rate of 1 Mbps and a difference between this bit rate and the network bandwidth is zero. Thus, according to manner 1, “ultra-high definition” should be selected in the present step. The present step can select the most appropriate definition for the user automatically according to the current network environment, and this not only avoids influent playing when the bit rate of the selected definition is too high but also avoids bad image quality when the definition selected having an excessively low bit rate. The present step can ensure the fluent playing while provide the best image quality for the user.

Manner 2: providing the obtained definitions having a bit rate less than or equal to the current network bandwidth to the user for selecting; and when one definition is detected to be selected obtaining the selected definition as the definition matching to the current network condition.

In this manner, the selectable definitions can be displayed to the user in the form of menus, buttons and radio buttons etc. and the user could select the intended definition himself. Playing the requested video with the definition selected by the user is most satisfying with the definition demand of the user.

Manner 3: providing the obtained definitions having a bit rate less than or equal to the current network bandwidth to the user for selecting and further suggesting a most appropriate definition to the user; when one definition is detected to be selected, obtain the selected definition as the definition matching to the current network condition. The most appropriate definition to the user, for example, is the definition matching to the current network condition obtained according to the manner 1.

In this manner, not only all the definitions matched by the current network bandwidth are displayed to the user, but also the most appropriate definition is suggested, and thus this manner would improve the watching experience to the maximum extent.

It is further to be noted that the above three manners can be applied flexibly according to real demands, and any one of them or any combination of them can be used.

The step S203 through the step S206 can be a more detailed implemention example of the step S102 in FIG. 5.

If the requested video supports more than one definition, the user can switch the definition during the playing process of the requested video. That is, the video playing method may further include:

Step S207, if a definition switching request from a user is received, recording the current playing time of the requested video.

In step S207, if a definition switching request from a user is received, the current playing time is located and recorded.

Step S208, obtaining a source URL corresponding to the target definition of the video, and downloading the requested video starting from the current playing time and then playing the downloaded video.

By the steps S207 and S208, the current playing time of the requested video can be located automatically when the user switches the definition. In other words, the current watching progress of the user is located and the requested video corresponding to the target definition is downloaded starting from the current playing time. As a result, the seamless playing between two different definitions is achieved, and the user gets the seamless watching experience when the definition is switched.

In the video playing method of the present embodiment, the most appropriate definition for the user is selected automatically to play the requested video according to the current network environment, and this avoids influent playing when the bit rate of the selected definition is not matching to the current network environment. The present embodiment can ensure the fluent playing.

Corresponding to the video playing method shown in FIGS. 5 and 6, the video playing module 124 is further described in detail with reference to FIGS. 7 through 12.

Referring to FIG. 7, which is a block diagram of a video playing apparatus provided in accordance with a third embodiment, the video playing module 124 includes: an information retrieving module 11, configured to retrieve description information associated with a requested video according to a video playing request launched by a user.

The user can launch the video playing request by selecting a video from a local playing list provided by the video playing module 124, or through loading a video playing webpage using a browser. The information retrieving module 11 retrieves the description information associated with the requested video form a server according to the video playing request. The description information includes definition information describing at least one supported definition of the requested video.

The video playing module further includes a network detecting module 12, configured to detect the current network condition.

The current network condition may include the current network bandwidth. The network detecting module 12 can utilize a known bandwidth detecting software or tool to detect the current network bandwidth of the user, and the detail detecting procedure can be referred to the known technique.

The video playing module 124 further includes a playing module 13, configured to select a definition matching to the current network condition detected by the network detecting module 12 to play the requested video.

The playing module 13 may select the definition matching to the detected current network bandwidth to play the requested video. The definition matching to the detected current network bandwidth refers to the definition which has a bit rate less than or equal to the current network bandwidth, in other words, has a bit rate not more than the current network bandwidth. For example, if the requested video support three definitions of “standard definition”, “high definition” and “ultra-high definition”, and the detected current network bandwidth is 480 Kbps, then the playing module 12 selects a definition having a bit rate not more than 480 Kbps to play the requested video. Referring to the listing table shown in FIGS. 3 and 4, the “standard definition” should be selected to play the requested video. In the present embodiment, by selecting a definition having a bit rate not more than the network bandwidth, the influent playing due to the inadequate bandwidth when the selected definition having a bit rate higher than the current network bandwidth is avoided.

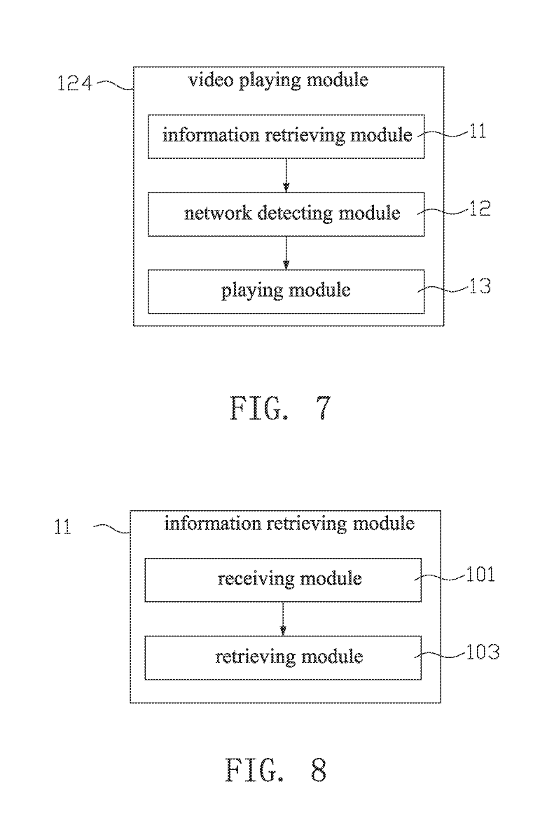

Referring to FIG. 8, which is a block diagram of an implemention example of the information retrieving module of the video playing module 124 shown in FIG. 7, the information retrieving module 11 includes: a receiving module 101, configured to receive the video playing request from the user.

The user can send the video playing request by selecting a video from a local playing list, or through loading a video playing webpage using a browser. The receiving module 101 receives the video playing request sent by the user using the above methods. The video playing request may include the ID or the name of the requested video.

The information retrieving module 11 further includes a retrieving module 103, configured to retrieve the description information associated with the requested video form the server according to the ID or the name of the requested video received by the receiving module 101.

The retrieving module 11 can retrieve the description information associated with the requested video from the server according to the ID or the name of the requested video sent by the user. For example, the retrieving module 11 can read the description information such as the definition information describing the supported definition of the requested video, the source URL of each definition from the listing table shown in FIGS. 3 and 4 according to the ID or the name of the requested video.

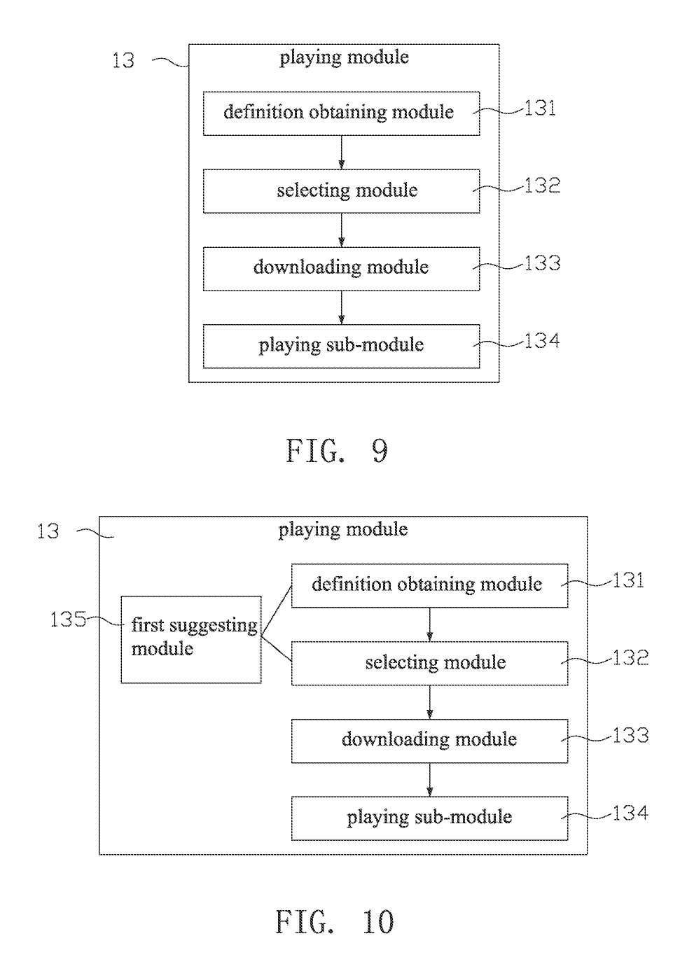

Referring to FIG. 9, which is a block diagram of a first implemention example of the playing module 13 of the video playing module shown in FIG. 7, the playing module 13 includes: a definition obtaining module 131, configured to obtain definition(s) having a bit rate less than or equal to the current network bandwidth according to the supported definition of the requested video.

The playing module 103 further includes a selecting module 132, configured to select a definition matching to the current network condition from the definitions obtained by the definition obtaining module 131. The current network condition is detected by a network detecting module.

The selecting module 132 can select a definition matching to the detected current network bandwidth according to the supported definition of the requested video, in other words, select a definition having a bit rate less than or equal to (not more than) the current network bandwidth. For example, as shown in FIG. 4, the film C supports two definitions: “standard definition” and “ultra-high definition”. If the detected current network bandwidth is 480 Kbps, then the selecting module 132 selects a definition having a bit rate not more than 480 Kbps to play. Referring to the listing table shown in FIGS. 3 and 4, the “standard definition” should be selected.

The playing module 103 further includes a downloading module 133, configured to obtain the source URL of the requested video corresponding to the selected definition and then download the requested video.

The downloading module 133 can obtain the source URL of the requested video corresponding to the selected definition from the server. For example, the “standard definition” is selected by the selecting module 132 for the film C, then the source URL of the film C corresponding to the “standard definition” represented by the ID “3” can be read from the listing table shown in FIGS. 1 and 2. After that, the film C can be downloaded to play according to the source URL.

The playing module 13 further includes a playing sub-module 134, configured to play the requested video downloaded by the downloading module 133.

The playing sub-module 134 can play the downloaded video in a window or a webpage navigated by a browser.

The selecting module 132, for example, is used to select a definition having a bit rate most close to the current network bandwidth from the obtained definitions having a bit rate less than or equal to the current network bandwidth. The primary objective of this manner is to select a definition having a bit rate most close to the current network bandwidth and this procedure may include, if at least one (e.g. two) definitions matching to the current network bandwidth are obtained by the definition obtaining module 131, the selecting module 132 compares the obtained definitions and the current network bandwidth, calculating the minimum difference between them, and selecting the definition that has the smallest difference. For example, the film C supports two definitions: “standard definition” and “ultra-high definition”. If the network bandwidth is detected to be 1 Mbps (1000 Kbps), as shown in FIGS. 3 and 4, then the two definitions “standard definition” and “ultra-high definition” would be both obtained by the definition obtaining module 131, wherein the “standard definition” has a bit rate of 300 Kbps and a difference between this bit rate and the network bandwidth is 700 Kbps; the “ultra-high definition” has a bit rate of 1 Mbps and a difference between this bit rate and the network bandwidth is zero. Thus, “ultra-high definition” should be selected by the selecting module 132. The downloading module 133 is also used to obtain the source URL corresponding to the definition selected by the selecting module 132, and download the requested video. The selecting module 132 can select the most appropriate definition for the user automatically according to the current network environment, and this not only avoids influent playing when the bit rate of the selected definition is too high but also avoids bad watching experience of the user when the definition selected having an excessively low bit rate. The present video playing apparatus can ensure the fluent playing while provide the best watching experience for the user.

Referring to FIG. 10, which is a block diagram of a second implemention example of the playing module 13, the playing module 13 includes: the definition obtaining module 131, the selecting module 132, the downloading module 133, and the playing sub-module 134. The playing module 13 may further include a first suggesting module 135, configured to provide the obtained definitions having a bit rate less than or equal to the current network bandwidth by the definition obtaining module 131 to the user for selecting.

If the definition obtaining module 131 selects at least one (e.g., two) definitions matching to the current network condition, the first suggesting module 135 can display the selectable definitions in the form of menus, buttons or radio button, and the user can select the intended definition himself. The selecting module 132 is used to obtain a selected definition as the definition matching to the current network condition when detecting that the definition is selected. The downloading module 133 obtains the source URL corresponding to the selected definition of the requested video, and then downloads the requested video to play.

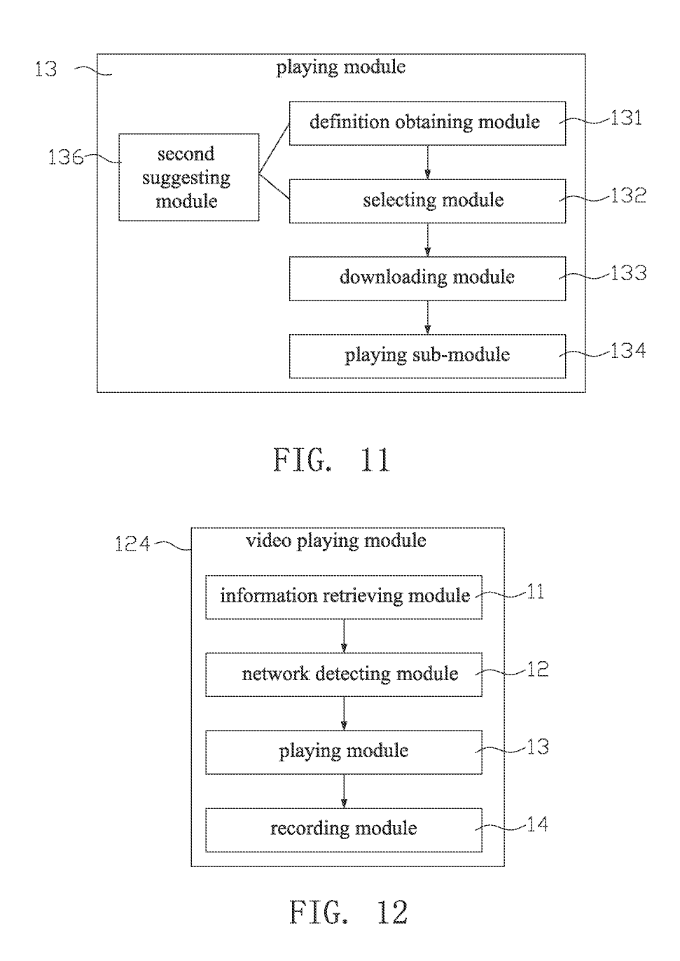

Referring to FIG. 11, which is a block diagram of a third implemention example of the playing module 13, the playing module 13 includes: the definition obtaining module 131, the selecting module 132, the downloading module 133, and the playing sub-module 134. The playing module 13 may further include a second suggesting module 136, configured to provide the obtained definitions having a bit rate less than or equal to the current network bandwidth to the user for selecting ,and further display a tip to suggest the most appropriate definition. The selecting module 132 is used to obtain a selected definition as the definition matching to the current network condition when detecting that the definition is selected.

Referring to FIG. 12, which is a block diagram of a video playing apparatus in accordance with a fourth embodiment, the video playing module 124 may include the information retrieving module 11, the network detecting module 12, and the playing module 13, and the video playing module 124 may further include a recording module 14, configured to record the current playing time of the requested video when receiving a definition switching request from the user.

If the requested video supports more than one definition, the user can switch the definition during the playing process of the requested video, the recording module 14 would locate the current playing time of the requested video, and record the current playing time. The playing module 13 is further configured to obtain the source URL of the requested video corresponding to the target definition, download the requested video starting from the recorded current playing time to play the requested video. The recording module 14 can locate the current playing time, in other words, the current watching progress, of the requested video automatically when the user switch the definition, and download the requested video starting from the current playing time. As a result, the seamless playing between two different definitions is achieved, and the user gets the seamless watching experience when the definition is switched.

According to the above described embodiments, during the video playing process, the definition matching to the current network environment is selected to play the requested video, and this avoids influent playing caused by the bit rate of the selected definition is mismatching with the current network environment, ensures the fluent playing.

It is to be noted for those ordinarily skilled in the art that the whole or part of the processes of the above video playing method can be achieved by computer executable instructions. In other words, the computer executable instructions are used to cause the computer or other similar computing apparatuses to perform the above video playing method. The computer executable instructions can be stored in a computer readable medium, and the computer readable medium may be a hard disk drive, a compact disk, a read-only memory (ROM), or a random access memory (RAM) etc.

The above descriptions are only preferred embodiments of the present invention, and are not intended to limit the present invention. Any amendments, replacement and modification made to the above embodiments under the principle of the present invention should be included in the scope of the present invention.

What is claimed is:

1. A video playing method, comprising:
receiving a video playing request from a user;
retrieving description information associated with a requested video designated by the video playing request, the description information comprising: definition information describing at least one supported definition of the requested video; and
detecting current network condition, and selecting a definition matching to the current network condition to play the requested video.

2. The video playing method of claim 1, wherein the description information further comprises: an identifier (ID) of the requested video, a name of the requested video, and a respective source URL of the requested video corresponding to each definition; and
the definition information comprises: an ID, a name and a bit rate of the definition.

3. The video playing method of claim 2, wherein retrieving description information comprises:
retrieving the description information associated with the requested video according to the ID or the name of the requested video.

4. The video playing method of claim 2, wherein detecting current network condition, and selecting a definition matching to the current network condition to play the requested video comprises:
detecting the current available network bandwidth;
obtaining definitions having a bit rate less than or equal to the current available network bandwidth according to the definition information of the requested video;
selecting a definition matching to the current available network bandwidth; and
obtaining a source URL corresponding to a selected definition of the requested video, downloading and playing the requested video.

5. The video playing method of claim 4, wherein selecting a definition matching to the current network condition comprises:
selecting a definition having a bit rate most close to the current network bandwidth from the obtained at least one definitions having a bit rate less than or equal to the current network bandwidth as the definition matching to the current network condition.

6. The video playing method of claim 4, wherein selecting a definition matching to the current network condition comprises:
providing the obtained definitions having a bit rate less than or equal to the current network bandwidth to the user for selecting; and
obtaining a selected definition as the definition matching to the current network condition when detecting the user selecting the selected definition.

7. The video playing method of claim 4, wherein selecting a definition matching to the current network condition comprises:
providing the obtained definitions having a bit rate less than or equal to the current network bandwidth to the user for selecting and further suggesting a most appropriate definition to the user; and
obtaining a selected definition as the definition matching to the current network condition when detecting the user selecting the selected definition.

8. The video playing method of claim 1, during a playing process of the requested video, further comprising:
recording a playing time of the requested video at a switching time when a definition switching request is received; and
obtaining a source URL corresponding to an target definition of the requested video, downloading the requested video starting from the playing time and playing the requested video.

9. A video playing terminal, comprising:
a memory;
one or more processors; and
one or more modules stored in the memory and configured for execution by the one or more processors, the one or more modules comprising instructions:
to receive a video playing request from a user;
to retrieve description information associated with a requested video designated by the video playing request, the description information comprising: definition information describing at least one supported definition of the requested video;
to detect current network condition; and
to select a definition matching to the current network condition to play the requested video.

10. The video playing terminal of claim 9, wherein the instructions to retrieve the description information comprises instructions to retrieve: an identifier (ID) of the requested video, a name of the requested video, and a respective source URL of the requested video corresponding to each definition, a name and a bit rate of the definition.

11. The video playing terminal of claim 10, wherein the instructions to retrieve the description information comprises instructions:
to retrieve the description information associated with the requested video according to the ID or the name of the requested video.

12. The video playing terminal of claim 11, wherein the instructions to detect current network condition comprises instructions:
to obtain definitions having a bit rate less than or equal to the current network bandwidth according to the definition information of the requested video;
to select a definition matching to the current network condition;
to obtain a source URL corresponding to a selected definition of the requested video and download the requested video; and
to play the requested video downloaded.

13. The video playing terminal of claim 12, wherein the instructions to select a definition matching to the current network condition comprises instructions to select a definition having a bit rate most close to the current network bandwidth from the obtained at least one definitions having a bit rate less than or equal to the current network bandwidth as the definition matching to the current network condition.

14. The video playing terminal of claim 12, wherein the instructions to play the requested video downloaded comprises instructions:
to provide the obtained definitions having a bit rate less than or equal to the current network bandwidth to the user for selecting; and
to obtain a selected definition as the definition matching to the current network condition when detecting the user selecting the selected definition.

15. The video playing terminal of claim 12, wherein t the instructions to play the requested video downloaded comprises instructions:
to provide the obtained definitions having a bit rate less than or equal to the current network bandwidth to the user for selecting and further suggest a most appropriate definition to the user; and
obtain a selected definition as the definition matching to the current network condition when detecting the user selecting the selected definition.

16. The video playing terminal of claim 9, wherein the one or more modules further comprises instructions:
to record a playing time of the requested video at a switching time when a definition switching request is received; and
the instructions to play the requested video downloaded comprises instructions to obtain a source URL corresponding to an target definition of the requested video, download the requested video starting from the playing time and play the requested video.

17. A computer readable medium, storing one or more programs, the one or more programs comprising instructions, which when executed by a video playing terminal, cause the video playing terminal to perform a method comprising:
receiving a video playing request from a user;
retrieving description information associated with a requested video designated by the video playing request, the description information comprising: definition information describing at least one supported definition of the requested video; and
detecting the current network condition, and selecting a definition matching to the current network condition to play the requested video.

18. The computer readable medium of claim 17, wherein detecting the current network condition, and selecting a definition matching to the current network condition to play the requested video comprising:
detecting the current available network bandwidth of the video playing terminal;
obtaining definitions having bit rate less than or equal to the current network bandwidth according to the definition information of the requested video;
selecting a definition matching to the current available network bandwidth; and
obtaining a source URL corresponding to a selected definition of the requested video, downloading and playing the requested video.

19. The computer readable medium of claim 18, wherein selecting a definition matching to the current network condition comprising:
selecting a definition having a bit rate most close to the current network bandwidth from the obtained at least one definitions having a bit rate less than or equal to the current network bandwidth as the definition matching to the current network condition.

20. The computer readable medium of claim 17, during a playing process of the requested video, further comprising:
recording a playing time of the requested video at a switching time when a definition switching request is received; and
obtaining a source URL corresponding to an target definition of the requested video, downloading the requested video starting from the playing time and playing the requested video.
